(19) United States
(12) Patent Application Publication
(10) Pub. No.: US 2010/0185644 A1
(43) Pub. Date: Jul. 22, 2010

(54) AUTOMATIC SEARCH SUGGESTIONS FROM CLIENT-SIDE, BROWSER, HISTORY CACHE

(75) Inventors: ZACHARY M. GUTT, SEATTLE, WA (US); JAMES F. GILSINAN, IV, REDMOND, WA (US); ALICE SU-CHIN YEH, Cambridge, MA (US); FARHAN ALI SALEEM, VANCOUVER (CA)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATOIN, REDMOND, WA (US)

(21) Appl. No.: 12/356,787

(22) Filed: Jan. 21, 2009

(51) Int. Cl. G06F 17/30

(52) U.S. Cl. 707/759; 707/E17.119

(57) ABSTRACT

An embodiment of the current invention is directed to using a script embedded in a web page and executed in a web browser environment to store user search history information in a persistent, browser-supplied, script accessible, history cache and employ the user search history information to provide suggested search queries. A number of input characters of a search query are received by the script. The persistent, browser-supplied, script accessible, history cache is retrieved. A list of suggested search queries is determined from the history cache by the script. The list of suggested search queries is presented.

### BACKGROUND

The amount of digital information and content available on computing devices continues to grow exponentially. Given the vast amount of digital information, search engines and other search technologies have been developed to assist users in locating specific information and documents. For instance, many search engines allow users to search for documents and information available on the Internet or World Wide Web. Additionally, it is now common for individual websites and application programs to provide a search box so that users can run queries for content on that website or within that application. Similarly, desktop search techniques allow a user to search for information and documents stored on his or her computer.

Search engines typically provide an input box that allows users to enter search queries that include one or more terms that may be of interest to the users. After receiving a search query from a user, a search engine identifies documents and/or web pages that are relevant based on the terms and displays search results to the user. Because of its utility, web searching, that is, the process of finding relevant web pages and documents for user issued search queries, has arguably become the most popular service on the Internet today.

Search engine providers have developed a variety of additional features to assist users in searching. For instance, many search providers offer query suggestion functionality in which a user, having entered a particular search query, is given a set of suggested search queries related to the user's search query. The user may select one of the suggested search queries causing a search to be performed using the selected suggested search query and search results to be returned to the user. In some implementations, suggested search queries may be automatically provided as the user types in their search query but before the user initiates a search. Additionally, some implementations employ the user's own search history to suggest search queries the user has issued in the past based on what they are currently entering. These solutions, however, require users to download, install, and maintain client software to get automatic search queries suggested from their search history.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section. This summary is not intended to identify key features or essential features of the claimed subject matter, nor is it intended to be used as an aid in isolation to determine the scope of the claimed subject matter.

Embodiments of the invention are related to a script delivered as part of a webpage and executable in a web browser environment to store search queries for use in provided suggested search queries. A query indication, including a search query, is received by the script. The search query is stored in a persistent, browser-supplied, script-accessible, history cache by the script. In some embodiments, when search results are returned in response to the search query, information regarding the search queries may also be stored in the history cache by the script.

Other embodiments of the present invention are related to a script delivered as part of a webpage and executable in a web browser environment for presenting a list of suggested search queries. A number of input characters are received by the script. A persistent, browser-supplied, script-accessible, history cache is retrieved. A list of suggested search queries from the history cache, based on the input characters, is determined by the script. The list of suggested search queries is presented. In some embodiments, the script may also request suggested search queries from a server and combine the suggested search queries from the history cache and the suggested search queries from the server to form a combined list of suggested search queries, which may be presented.

### BRIEF DESCRIPTION OF THE DRAWINGS

Illustrative embodiments of the present invention are described in detail below with reference to the attached drawing figures, which are incorporated by reference herein and wherein:

FIG. 1 depicts a block diagram of an exemplary computing environment suitable for implementing an embodiment of the invention;

FIG. 2 depicts a block diagram of an exemplary network environment suitable for implementing an embodiment of the invention;

FIG. 3 depicts a screen display of the presentation of suggested search queries, in accordance with an aspect of the present invention;

FIG. 4 depicts a screen display of the presentation of a suggested search result, in accordance with an aspect of the present invention;

FIG. 5 is a flow diagram showing a method of storing a search query in a history cache for use in providing suggested search queries by a script embedded in a webpage, in accordance with an aspect of the present invention;

FIG. 6 is a flow diagram showing a method of storing selected search results in a history cache for using in providing suggested search results by a script embedded in a webpage, in accordance with an aspect of the present invention;

FIG. 7 is a flow diagram showing a method of presenting a list of suggested search queries generated by a script embedded in a webpage using a history cache, in accordance with an aspect of the present invention;

FIG. 8 is a flow diagram showing a method of presenting a list of suggested search queries generated by a script embedded in a webpage using a history cache, in accordance with another aspect of the present invention; and

FIG. 9 is a flow diagram showing a method of displaying a suggested search result by a script embedded in a webpage using a history cache, in accordance with an aspect of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As users type search queries into a text-input element with search engine-query-functionality, it is often convenient to provide suggested search queries as the user types. Such search query suggestions can be determined through a number of different ways. By way of example only, search engines may have lists of popular search queries stored in a persistent storage that may be used to generate suggested search queries. Additionally, many search engines may have algorithms to provide suggested search queries that may, for instance, help narrow the focus of a user's search query to provide results more sharply directed toward a specific topic. In addition to drawing suggested search queries from search-engine-maintained lists and algorithms, suggested search queries for a given user could be drawn from that user's own search history. Traditionally, a user's search history can be stored on the user's computing device and accessed by programs executing locally on the user's computing device. In particular, a program or tool-bar is traditionally required to be installed on the user's computer to maintain and access a search history stored on the user's computing device.

Embodiments of the present invention are directed to using a history cache on the user's computing device to store the user's search history and to provide suggested search queries and/or suggested search results as a user enters a search query into a query input box on a web page providing search functionality. The suggested search queries and/or suggested search results may be provided while the user is entering a search query but before the user completes the search query and/or provides an indication to submit the search query for a search to be performed. In embodiments, the history cache is a persistent, browser-supplied, script-accessible cache that is employed to store information regarding a user's search history, including submitted search queries and interaction with search results. Those skilled in the art will recognize that a number of persistent, browser-supplied, script-accessible storage objects could be used to implement such a history cache. Embodiments of the present invention employ scripts embedded in web pages to cause search history information to be stored in the history cache and allow the scripts to access the search history information to provide suggested search queries and/or suggested search results to a user as the user enters a search query. In further embodiments of the present invention, suggested search queries and/or suggested search results from the history cache may be combined with suggested search queries and/or suggested search results provided from a search engine remote from the user's computing device.

In accordance with various embodiments of the present invention, persistent, browser-supplied, script-accessible caches can be implemented using a number of different methods. By way of example only and not limitation, the INTERNET EXPLORER browser provides a persistent-storage feature that is suitable for use in implementing an aspect of the present invention. The userData object provides a means to store a large amount of persistent data that is accessible through scripts executing in the INTERNET EXPLORER browser. Using the userData object, a user-related cache of past searches could be maintained by a script executed by the browser, implementing the search-query-input element functionality. A supercookie is a cache stored using the userData object, for use in the INTERNET EXPLORER browser.

As another example, the FIREFOX browser provides a persistent-storage feature that is also suitable for use in implementing an aspect of the present invention. Document Object Model (DOM) storage objects are persistent, user-related storage objects that can be used by scripts executed by a browser on behalf of a web page. There are a number of global objects defined by the DOM specification. Storage is the standard interface from which all other storage objects are derived. There are two main subclasses of the Storage object that can be used to implement persistent storage. These are sessionStorage and globalStorage. For storing data that should persist for the life of a single session (e.g., from the time a browser window is open to the time it is closed), sessionStorage provides a data-storage object. For longer-term storage requirements, globalStorage provides a data-storage object. Using the globalStorage object, a user-related cache of past searches could be maintained by a script executed by the browser, implementing the search-query, input-element functionality.

Those skilled in the art will recognize that the above-noted storage objects are provided by way of example only and similar storage objects and methods can be defined for various scripting languages and other browsers that would be suitable for implementation of the user-related, search-history cache of the present invention.

As used herein, the term “scripts” refer to segments of code delivered by a web server in association with a webpage that are then executed in a web browser environment on a client computing device. The scripts may be executed by the web browser or on behalf of the web browser, for instance, in a JavaScript engine. Scripts do not require installation and have limited access to resources on the computing device on which they are executing. For example, scripts cannot access all local data storage areas. Such scripts can affect the appearance of the webpage in which they are embedded, post to and receive data from web servers, access special memory locations on the local computing device, and define other interactive functionality for the webpage in which they are embedded.

In accordance with an embodiment of the present invention, a script, implementing a method of providing suggested search queries can use a persistent, browser-supplied, script-accessible, user-related cache to store and access user-related, search histories. In some embodiments, a script can also query a search engine for suggested search queries from popular searches and algorithm derived query suggestions, based on a partially completed search query entered by a user. The suggested search queries from the user's search history and from the search engine can then be combined, removing any duplicate entries, and provided to the user as suggested search queries for possible selection. Those skilled in the art will recognize that there are many languages suitable for creating the script used for accessing the history cache and the search engine that do not require a separate browser plugin or application to be installed. For example, JavaScript is a scripting language that could be used in the implementation, in accordance with an embodiment of the invention.

Those skilled in the art will recognize that there are many ways in which the suggested search queries could be presented to the user, in accordance with various embodiments of the present invention. For example, a drop-down box could be rendered below the search-query, input box. The drop-down box could then be populated with a number of the suggested search queries. The drop-down box could implement a number of different functions, including allowing a search query to be performed on an element of the drop-down box as a reaction to a mouse click on one of the suggested search queries.

In some embodiments, suggested search results may be presented in addition to suggested search queries. The suggested search results may comprise search results with which a user has interacted in response to a search query. For instance, a suggested search result may be selected for a given suggested search query based on the number of times the user has selected the search result in past searches and/or dwell time associated with the search result. Additionally, suggested search results may be provided to a user in a number of different manners within the scope of embodiments of the present invention. For example, when a user uses a mouse to hover over one of the suggested search queries, in accordance with an embodiment of the present invention, a search result associated with that particular, suggested search query could be displayed. The suggested search result could be identified from the persistent, browser-supplied, script-accessible cache storing the user's search history. Displaying the suggested search result would allow a user to select the search result and go immediately to that result without the need of performing a search query.

Search results can be added to the persistent, browser-supplied, script accessible cache by a script included in a web page presenting search results, in accordance with an embodiment of the current invention. There are a number of formats in which such search results could be stored, including as pairs, paired with the search queries in the history cache on the user's computing device.

Accordingly, an embodiment of the invention is directed to computer-readable media storing computer-executable instructions for performing a method of storing search queries for use in providing suggested search queries. A query indication is received, indicating a query is to be performed. The indication includes a search query. The search query is stored in a persistent, browser-supplied, script-accessible, history cache.

Another embodiment of the invention is directed to computer-readable media storing a script embedded in a webpage. The script contains instructions for performing a method of presenting a list of suggested search queries generated by the script embedded in a webpage. A number of input characters of a search query are received. A persistent, browser-supplied, script-accessible, history cache is retrieved. A list of history suggestions is determined from the history cache, based on the input characters, forming suggested search queries. The list of suggested search queries, based at least in part on the suggested search queries from the history cache, are presented.

A further embodiment of the invention is directed to computer-readable media storing a script embedded in a webpage. The script contains instructions for performing a method of presenting a list of suggested search queries generated by the script embedded in a webpage. A plurality of input characters of a search query are received. A list of suggested search queries is requested from a search engine server. A list of suggested search queries, including a list of popular searches and a list of alternative-query suggestions is received from the search engine server. Duplicate entries in the list of suggested search queries are removed. A persistent, browser-supplied, script-accessible, history cache is retrieved. A list of suggested search queries, based on the plurality of input characters, is determined by the script. The list of suggested search queries from the history cache and the list of suggested search queries from the search engine server is combined to form a combined list of suggested search queries. Duplicate entries from the combined list of suggested search queries are removed. The combined list of suggested search queries is presented.

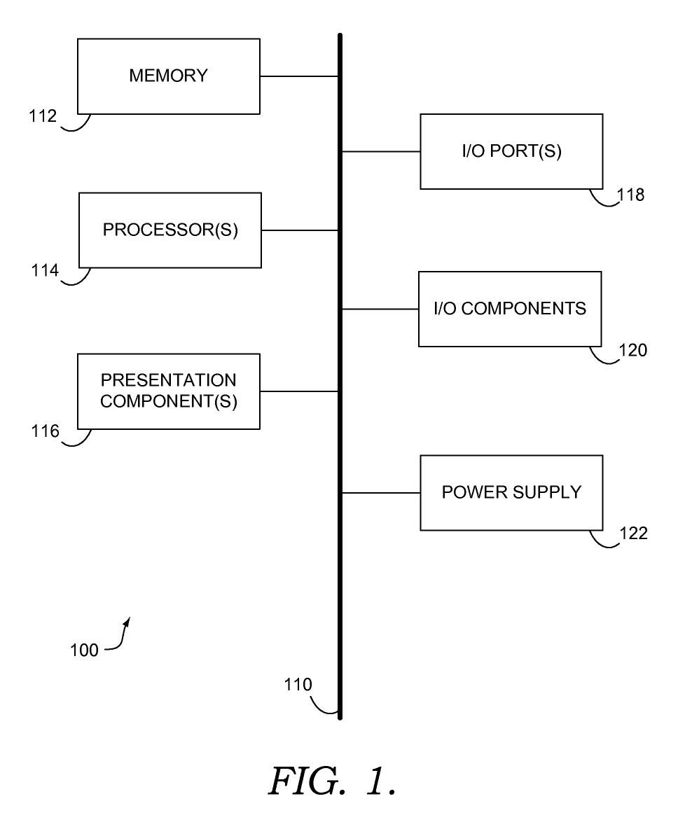

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, many processors have memory. We recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, Random-Access Memory (RAM), Read-Only Memory (ROM), Electrically-Erasable, Programmable, Read-Only Memory (EEPROM), flash memory or other memory technology, Compact Disk, Read-Only Memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile memory. Exemplary hardware devices include solid-state memory, such as RAM. Memory 116 includes computer-storage media in the form of non-volatile memory. The memory 116 may be removable, nonremovable, or a combination thereof. Exemplary hardware devices include solid-state memory, hard drives, optical-disc drives, etc. Computing device 100 includes one or more processors 114 that read data from various entities such as memory 112 or I/O components 120. I/O components 120 present data indications to a user or other device. Exemplary output components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

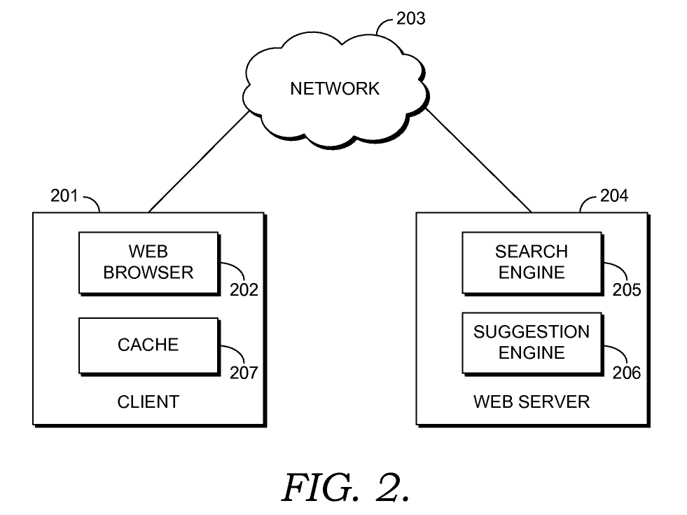

Referring to FIG. 2, a block diagram presenting a network suitable for supporting embodiments of the current invention is depicted. A client computing device 201 connected to a network 203 is running a web browser application 202 and is supplying a persistent, browser-supplied, script-accessible cache 207. The network 203 could be an intranet or a connection to the Internet. Those skilled in the art will recognize that the web browser application 202 could be any application capable of interacting with a search engine and displaying results. For example, the INTERNET EXPLORER browser and the FIREFOX browser could be used as the web browser application 202.

The persistent, browser-supplied, script-accessible cache 207 provides a data store that is user-related and accessible via scripts executing on behalf of a web page being rendered by the browser application 202. In accordance with an embodiment of the invention, the cache can be created and maintained using a supercookie. Supercookies can be implemented using the userData object. In accordance with a further embodiment, the cache can be created and maintained using DOM storage objects.

A web server 204 is also connected to the network. The web server 204 is running a search engine 205 and a suggestion engine 206. The suggestion engine 206 is responsible for providing suggested search queries, which may be derived from a number of resources stored on the server. For example, the web server 204 can store lists of popular search queries. The suggestion engine 206 can match the input characters to the characters in each of the popular searches in the list of popular searches and generate a list of closely matching suggested search queries. Additionally, the suggestion engine 206 may be able to generate alternative-query suggestions, which are suggestions to help users disambiguate query searches, or are suggestions that narrow the search results to a particular media type, such as images or videos. These alternative-query suggestions can be combined with the list of matching popular searches to form a list of suggested search queries that are returned to the client. Those skilled in the art will recognize that the suggestion engine 206 and the search engine 205 could run on separate machines, or on the same machine as the web browsing application 202. Additionally, a number of other components and devices not shown in FIG. 2 may be included to provide search-related functionality.

In accordance with an embodiment of the present invention, the web server 204 delivers a web page to the client 201 containing one or more scripts. The web browser 202 on the client 201 executes these scripts while rendering the web page. In some instances, the web page may include an input box for receiving a search query, and the script could cause a search query entered by the user to be stored in the persistent, browser-supplied, script-accessible cache 207. In some instances, the web page could include search results in response to a search query issued to the search engine 205, and the script could access the persistent, browser-supplied, script-accessible cache 207, inserting information regarding user interaction with search results. For instance, the script could cause selected search results to be stored in associated with a search query.

Additionally, the one or more scripts could, as a user types a search query string, capture characters entered and perform lookups, both to the suggestion engine 206 on the server 204 and to the persistent, browser-supplied, script-accessible cache 207 on the client 201. The script or scripts could then combine the results of the various lookups and present them as suggested search queries. In some embodiments, suggested search results may be provided in addition to the suggested search queries.

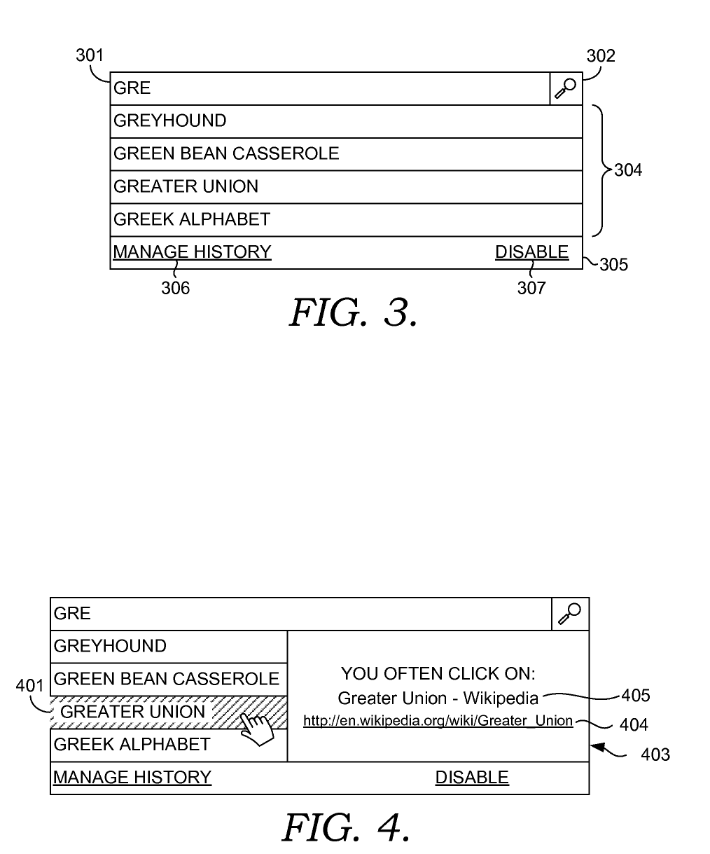

Turning now to FIG. 3, a screen display is provided that illustrates an input element 301 and suggested search queries 304, according to an embodiment of the invention. The input element 301 can accept user input, whereby a user would type a character string representing a desired search query. In accordance with embodiments, a script is attached to the input element 301 that captures each character in the character string as the characters are typed by the user. The script can then acquire suggested search queries according to an embodiment. In some embodiments, suggested search queries are not retrieved until a threshold number of characters has been entered. For example, the script could collect three characters before initiating a request for suggested search queries. According to some embodiments, the script could request new, suggested search queries after each n characters entered after the initial query completion suggestion request. By way of example, the script could request a new list of suggested search queries after each character entered. As another example, the script could request a new list of query completion suggestions after every third character entered. In some embodiments, a timer could be used to trigger a request for new suggested search queries. For example, a new list of suggested search queries could be requested every n milliseconds. Any and all such variation are contemplated to be within the scope of embodiments of the present invention.

A search button 302 is provided to allow the user to indicate that a search using the selected or entered search query is to be initiated. A suggestion display area 304 is presented that contains a number of suggested search queries for the acquired list of query completion suggestions. Those skilled in the art will recognize that there are a number of forms the suggestion display area 304 could take. By way of example, the suggestion display area 304 could be a drop-down box. As another example, the suggestion display area 304 could be a fixed length box with a scroll bar.

In operation, a user could begin entering text into the input element 301. By way of example, the user could input “GRE” into the input element 301. A script delivered by the web server, embedded in the web page could then request suggested search queries. Upon the receipt of the suggested search queries by the script, the suggestion display area 304 could be populated with the results. For example, as a response to the input “GRE” in the input element 301, the suggestion display area 304 could be populated with “GREYHOUND,” “GREEN BEAN CASSEROLE,” “GREATER UNION,” and “GREEK ALPHABET.”

A status bar 305 is also present in the embodiment illustrated in FIG. 3. The status bar 305 can contain hyperlinks to configuration options. For example, the status bar 305 can contain a hyperlink to manage the history that is used to generate the suggestions 306. Additionally, some users may find it desirable to disable the query completion functionality. A hyperlink allowing users to disable the functionality 307 can also be displayed on the status bar 305.

Turning to FIG. 4, according to an embodiment of the present invention, a suggested search result related to an indicated, suggested search result can also be displayed. For instance, a user can position a cursor 402 over a suggested search query 401. The hovered-over, suggested search query 401 can be indicated as selected through a number of means. By way of example, the background color behind the selected, suggested search query 401 could be changed. As another example, the border around the selected, suggested search query 401 could be changed. Those skilled in the art will recognize that there are many ways a suggested search query 401 could be indicated. By way of example, keyboard input could also be used to indicate a suggested search query 401.

Once a selected, suggested search query is indicated, a display area 403 for displaying a suggested search result associated with the selected, suggested search query can be presented. Those skilled in the art will recognize that the display area 403 can display various information about the suggested search result. By way of example, the site title 405 and the URL of the site 404 can be displayed. As another example, a summary of the text on the page could be displayed. Users could then click on the suggested search result and go directly to the referenced website without having to perform the actual, suggested search query and click on the result from the subsequent search results page.

The suggested search result can be determined by searching the history cache, in accordance with an embodiment of the invention. When users choose links from a search-engine results page, the chosen result can be stored in the history cache along with the search query used to generate the results page. Those skilled in the art will recognize that there are many ways that the suggested search result could be tracked using the history cache. By way of example, each viewed search result related to a particular search query could be stored along with a click counter. Then, the most-viewed search result could be determined as the suggested search result for the search query by comparing each viewed search result's associated click counter and returning the search result with the highest, counter value. In other embodiments, other information, such as dwell time, may be tracked and used to determine a suggested search result for a given search query.

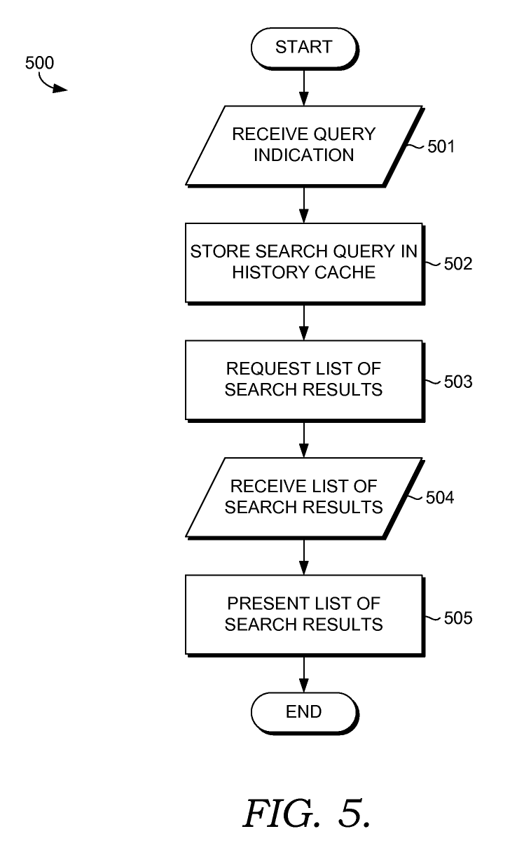

Turning now to FIG. 5, a flow diagram is provided depicting a method 500 of storing search queries for use in providing suggested search queries by a script embedded in a webpage, in accordance with an embodiment of the present invention. As discussed previously, a web page having a text-input box with search functionality is provided with an embedded script. A query indication, indicating a query is to be performed is received by the script, as shown at block 501. According to an embodiment of the invention, a search query is included with the indication. For instance, a user may enter a search query into the text-input box and select a submit button to submit the search query to a search engine.

The search query included in the indication is stored in a history cache by the script, as shown at block 502. As discussed previously, the history cache is a persistent, browser-provided, and script-accessible cache that could be implemented in a number of different ways, including, for instance, using a DOM storage object and a supercookie.

A list of search results based on the search query is requested from a search engine, as shown at block 503. A list of search results is received, as shown at block 504, and the list of search results is presented, as shown at block 505. According to an embodiment of the invention, the search results are displayed on a search engine results page.

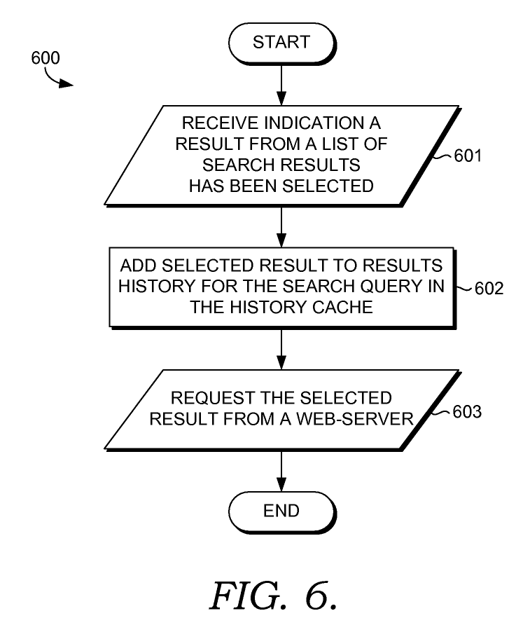

Turning now to FIG. 6, a flow diagram is provided presenting a method 600 of adding information regarding search results to a history cache by a script embedded in a webpage, in accordance with an embodiment of the present invention. A web page containing search results may be provided with an embedded script that facilitates storing information regarding user interactions with the search results in a history cache. An indication that a result has been chosen from a list of search results is received by the script, as shown at block 601. By way of example, the indication can be generated by a user clicking on one of the search results presented in a list of search results. The selected result is added to a persistent, browser-supplied, script-accessible, history cache by the script, as shown at block 602. According to an embodiment, the search result is added to the history cache and associated with the search query. According to another embodiment, a click count is associated with the search result. If the search result already exists as a search result associated with the search query in the history cache, then the associated click count is incremented. Those skilled in the art will recognize that there are many ways the history cache could be organized to store information about search results related to a search query. The selected search result is requested from a web server, as shown at block 603.

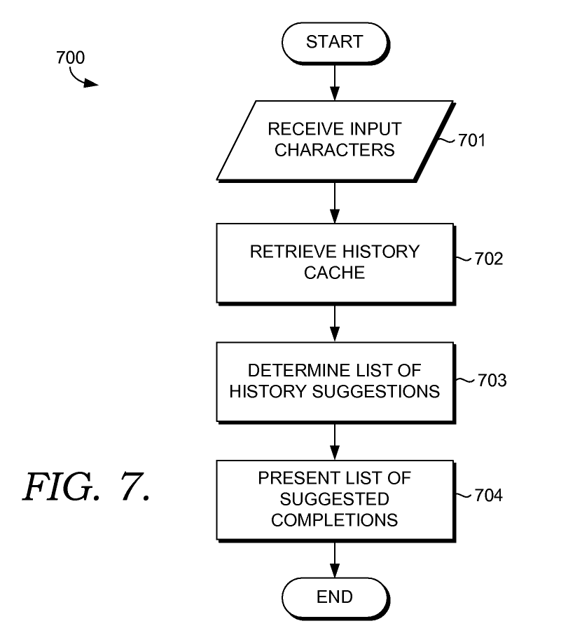

Turning now to FIG. 7, a flow diagram is provided depicting a method 700 of presenting a list of suggested search queries generated by a script embedded in a webpage using a history cache, in accordance with an embodiment of the present invention. As discussed previously, a web page having a text input box providing search functionality can be provided with a script that facilitates providing suggested search queries. When a user enters a search query in the text input box, a number of input characters are received by the script, as shown at block 701. According to an embodiment of the invention, the input characters are entered by the user into an input element of a query page. Those skilled in the art will recognize that the number of input characters used to provide a first list of suggested completions can vary. By way of example, three or more characters could be used to generate a list of suggested completions.

A history cache is retrieved, as shown at block 702. As previously noted, there are numerous ways that the history cache could be implemented that would provide a persistent, browser-supplied, script-accessible cache. By way of example, a supercookie could be used to implement the history cache. As another example, a DOM storage object could be used to implement the history cache. A list of suggested search queries is determined from the history cache by the script, as shown at block 703. According to an embodiment of the invention, the history cache is searched for search queries based on the sequence of input characters received in block 701. Those skilled in the art will recognize that there are other ways in which suggested search queries could be determined based on the input characters and the history cache.

The list of suggested search queries is presented, as shown at block 704. Those skilled in the art will recognize that there are a number of ways that the list could be presented. By way of example, the list of suggested completions could be presented in a drop-down box on a search engine query page. As another example, the list of suggested completions could be presented on a search-engine, results page. As discussed previously, in some embodiments, the script may cause suggested search results to also be identified from the history cache for suggested search queries. The suggested search results may be presented to the user in association with the suggested search queries. Those skilled in the art will recognize that there are many ways in which the suggested search results could be presented. For example, the history suggestions could be presented in one font color and the non-history suggestions could be presented in a second font color.

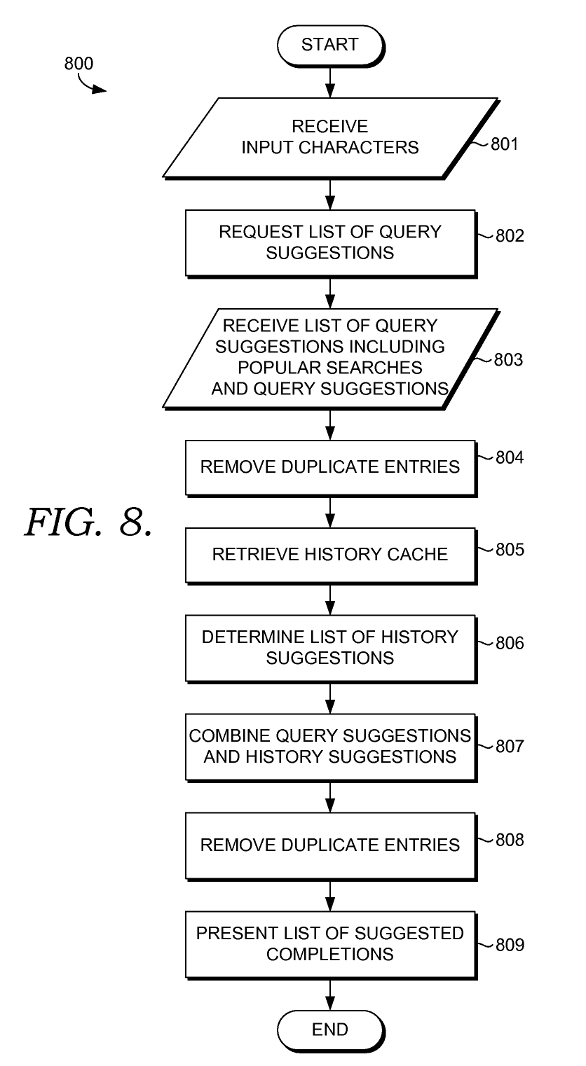

Referring to FIG. 8, a flow diagram is provided presenting a method 800 of presenting a list of suggested search queries generated by a script embedded in a webpage, in accordance with an embodiment of the present invention. As a user enters a search query, a plurality of input characters is received by the script, as shown at block 801, similar to block 701 of FIG. 7. A list of suggested search queries is requested by the script from a server running a search engine, as shown at block 802. The suggested search queries provided by the search engine may include, for instance, search queries of popular searches and alternative-query suggestions. A list of suggested search queries is received by the script from the search engine, as shown at block 803. The list of suggested search queries from the search engine may include, for instance, a list of popular searches and alternative-query suggestions. Those skilled in the art will recognize that the list of popular searches could be an empty list. Additionally, the list of alternative-query suggestions could be an empty list. Duplicates are removed from the received list of query suggestions, as shown at block 804.

A history cache is retrieved by the script, as shown at block 805. The history cache can be a persistent, browser-supplied, script-accessible cache. A list of suggested search queries is determined from the history cache, based on the input characters, by the script, as shown at block 806, similar to block 703 of FIG. 7. The list of suggested search queries from the search engine and the suggested search queries from the history cache are combined by the script, forming a new list of suggested search queries, as shown at block 807. Those skilled in the art will recognize that it is possible for duplicate entries to exist in the created list of suggested completions. Duplicates are removed from the list of suggested completions by the script, as shown at block 808. The list of suggested completions are presented, as shown at block 809, similar to block 704 of FIG. 7.

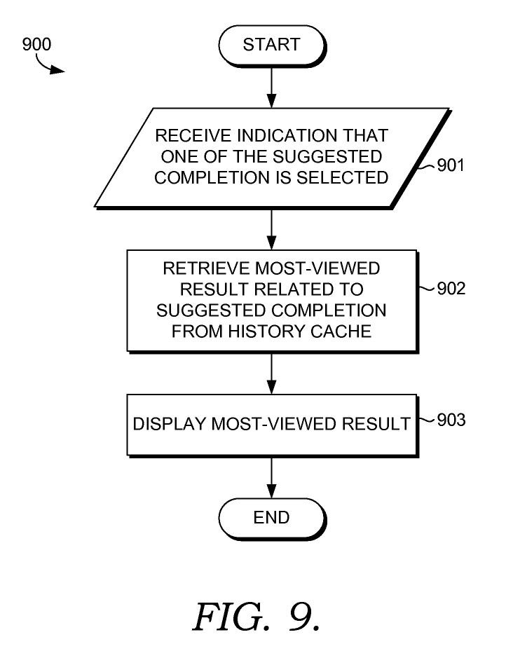

Turning now to FIG. 9, a method 900 is presented of presenting a suggested search result in relation to a suggested search query by a script embedded in a webpage, in accordance with an embodiment of the present invention. An indication that one of a list of suggested search queries is selected is received by the script, as shown at block 901. According to some embodiments, the indication can be generated by hovering a cursor over one of the list of suggested search queries. Those skilled in the art will recognize that there are a number of ways an indication that a selection has been made could be generated. By way of example, keyboard input could also be used to generate the indication.

The suggested search result related to the selected, suggested completion is retrieved by the script from a persistent, browser-supplied, script-accessible, history cache, as shown at block 902. The suggested search result is displayed, as shown at block 903. Those skilled in the art will recognize that there are a number of ways the most viewed-result could be displayed. By way of example, a pre-defined area next to the displayed list of suggested completions could be used to display the most-viewed result. As another example, a pop-up window could be used to display the most-viewed result.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media storing a script embedded in a webpage, the script comprising computer-executable instructions executable in a web browser environment for performing a method of storing search queries for use in provided suggested search queries, the method comprising:
receiving a query indication, indicating a search is to be performed, the query indication including a search query; and
storing the search query in a history cache, wherein the history cache is a persistent, browser-supplied, script-accessible cache.

2. The media of claim 1, wherein the method further comprises:
requesting a list of search results from a search engine, wherein in response, the list of search results are received from the search engine and presented on a search engine results page.

3. The media of claim 1, wherein the method further comprises:
receiving an indication, indicating a selected result from the list of search results;
adding the selected result to a results history for the search query in the history cache.

4. The media of claim 1, wherein the history cache is stored in a supercookie.

5. The media of claim 1, wherein the history cache is stored in a DOM storage object.

6. One or more computer-readable media storing a script embedded in a webpage, the script comprising computer-executable instructions executable in a web browser environment for performing a method of presenting a list of suggested search queries, the method comprising:
receiving a plurality of input characters of a search query;
retrieving a history cache, wherein the history cache is a persistent, browser-supplied, script-accessible cache;
determining suggested search queries from the history cache based on the plurality of input characters; and
presenting a list of suggested search queries based at least in part on the suggested search queries from the history cache.

7. The media of claim 6, wherein the method further comprises:
requesting suggested search queries from a server;
receiving the suggested search queries from the server;
combining at least a portion of the suggested search queries from the history cache and at least a portion of the suggested search queries from the server, forming a combined list of suggested search queries; and
wherein presenting the list of suggested search queries comprises presenting the combined list of suggested search queries.

8. The media of claim 7, wherein the list of query suggestions comprises a list of popular searches and a list of query suggestions.

9. The media of claim 6, further comprising:
receiving an indication, indicating one of the list of suggested search queries as a selected, suggested search query;
retrieving a suggested search result related to the selected, suggested search query from the history cache; and
displaying the suggested search result.

10. The media of claim 7, wherein the receiving suggested search queries from the server further comprises removing duplicate entries from the suggested search queries from the server.

11. The media of claim 6, wherein the history cache is stored in a supercookie.

12. The media of claim 6, wherein the history cache is stored in a DOM storage object.

13. The media of claim 7, wherein the combining the suggested search queries from the history cache and the suggested search queries from the server includes removing duplicate entries from the combined list of suggested search queries.

14. The media of claim 9, wherein the indication, indicating the selected, suggested completion comprises an indication triggered by a hovering action.

15. The media of claim 9, wherein the displaying the suggested search result comprises displaying the suggested search result as a hyperlink.

16. The media of claim 6, wherein the presenting the list of suggested search results comprises presenting the list of suggested search results in a dropdown box on a search engine query page.

17. The media of claim 6, wherein the presenting the list of suggested search queries comprises presenting the list of suggested search queries in a dropdown box on a search engine results page.

18. One or more computer-readable media storing a script embedded in a webpage, the script comprising computer-executable instructions executable within a web browser environment for performing a method of presenting a list of suggested search queries, the method comprising:
receiving a plurality of input characters of a search query;
requesting a list of suggested search queries from a search engine server;
receiving the list of suggested search queries from the search engine server, including a list of popular searches and a list of query suggestions;
removing duplicate entries from the list of suggested search queries from the search engine server;
retrieving a history cache, wherein the history cache is a persistent, browser-supplied, script-accessible cache;
determining a list of suggested search queries from the history cache based on the plurality of input characters by the script;
combining the list of suggested search queries from the search engine server and the list of suggested search queries from the history cache, forming a combined list of suggested search queries;
removing duplicate entries from the combined list of suggested search queries; and
presenting the combined list of search queries.

19. The media of claim 18, wherein the history cache is stored in a supercookie.

20. The media of claim 18, wherein the history cache is stored in a DOM storage object.
